(19) United States
(12) Patent Application Publication
(10) Pub. No.: US 2006/0120296 A1
(43) Pub. Date: Jun. 8, 2006

(54) Auto mode detection for a switch

(76) Inventor: Ban Hok Goh, Singapore (SG)

Correspondence Address: SLATER & MATSIL LLP, 17950 PRESTON ROAD, SUITE 1000, DALLAS, TX, 75252, US

(21) Appl. No.: 11/002,720

(22) Filed: Dec. 2, 2004

(51) Int. Cl. H04L 12/28

(52) U.S. Cl. 370/252; 370/419; 370/465

(57) ABSTRACT

There is provided a method and apparatus for determining whether the mode of operation of a physical layer device (PHY) in an Ethernet switch is TBI, MII or GMII and for setting the Ethernet switch to that mode. The method comprises the steps of detecting the clock frequency of a signal received on the PHY; determining whether the clock frequency is a first frequency, the first frequency being an operating frequency of TBI; if the clock frequency is the first frequency, setting the switch to TBI mode; determining whether the clock frequency is a second frequency, the second frequency being an operating frequency of MII; if the clock frequency is the second frequency, setting the switch to MII mode; determining whether the clock frequency is a third frequency, the third frequency being an operating frequency of GMII; and, if the clock frequency is the third frequency, setting the switch to GMII mode. The interface on the switch side is changed in accordance with the particular frequency detected.

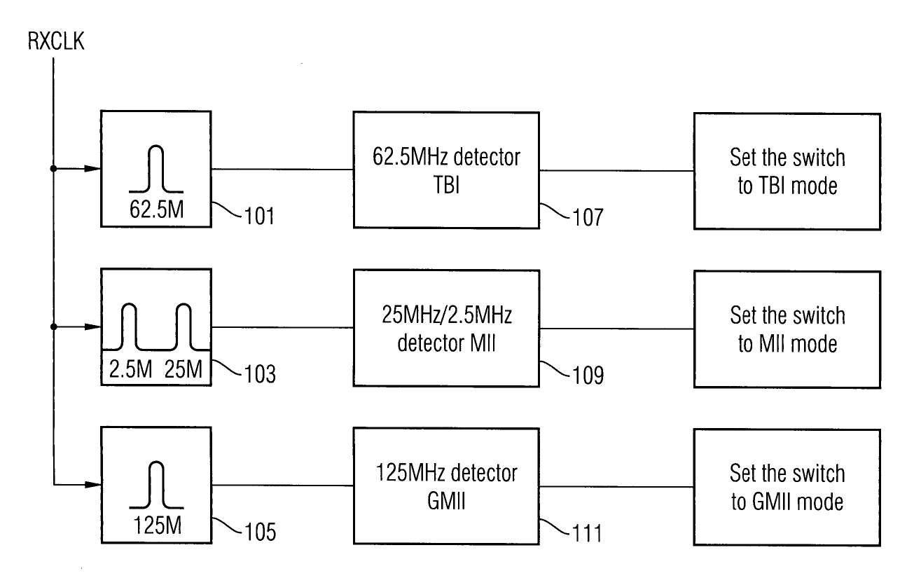

### TECHNICAL FIELD

The invention relates to a method and apparatus for determining the mode of operation of the physical layer device (PHY) in a switch and for setting the switch to that mode of operation. Particularly, but not exclusively, the invention relates to a method and apparatus for determining whether the mode of operation of the PHY in an Ethernet switch is TBI (Ten Bit Interface), MII (Medium Independent Interface) or GMII (Gigabit MII) and for setting the Ethernet switch to that mode.

### BACKGROUND

Ethernet is one of the most widely deployed LAN (local area network) technologies.

An Ethernet switch supports various interfaces (standards) for communicating across the Ethernet via physical link media. Various interfaces for communicating are defined, for example MII (Medium Independent Interface), GMII (Gigabit Medium Independent Interface) and TBI (Ten Bit Interface). There are many examples of physical link media, for example twisted copper pairs, optical fibers, coaxial cable and wireless systems. Different interfaces support different physical link media. For example, MII and GMII support copper CAT 5 cable, whereas TBI supports fiber cable.

An Ethernet switch typically includes both a PHY device and a MAC (Medium Access Control) device. The PHY interfaces between the MAC and the physical link medium. The PHY device handles the actual data transfer over the physical link medium to which it is connected. The MAC device controls the transmission of frames using the PHY layer. The PHY the MAC must work in the same interface or mode, which means that for a mode swap at the MAC level, there must also be a swap at the PHY layer (i.e., a change of the PHY module).

To date, the detection of the various interfaces and swapping between the different modes has been achieved by the use of power strapping pins. During power up or a restart, the power strapping values are read into the switch chip and the chip will configure to the appropriate mode. However, there are several problems with this arrangement.

Firstly, the mode is only configured at power up and there is no opportunity for a swap of the physical (PHY) layer after power on. If the user wishes to change mode, he will have to restart the system to allow the switch chip to reconfigure to the new mode. This is disadvantageous because the restart means that the entire traffic flow is affected. The amount of downtime is high.

Secondly, the use of power strapping pins for the detection of various interfaces has disadvantages. The pins may be shared with other signals and this may create some electrical differences when the line is being pulled up or pulled-down with various different resistor values. In addition, the pins themselves draw current and there may be interference between pins. Customers do not favor the use of strapping pins as there is concern that their use increases the cost of running a system (as there may be impedance matching and active pull up issues and, in any case, the system is not fully optimized).

### SUMMARY OF THE INVENTION

In one aspect, the invention provides a method and apparatus for determining the mode of operation of the PHY in a switch and for setting the switch to that mode of operation, which mitigates or substantially overcomes the problems of known systems described above.

In general terms, embodiments of the invention propose that the frequency of the PHY clock signal be detected and the appropriate interface be set depending on the frequency detected. This relies on the fact that different interfaces or modes operate at different clock frequencies so the appropriate interface can be determined based on the detected frequency. Therefore, a mode swap without a restart (commonly known as a “Hot Swap”) is facilitated.

More specifically, according to an embodiment of the invention, there is provided a method for determining, in a switch, the physical layer device (PHY) interface and for setting the switch to that interface, the method comprising the steps of:

a) detecting the clock frequency of a received signal;

b) determining whether the clock frequency is a first frequency, the first frequency being an operating frequency of a first PHY interface, or whether the clock frequency is a second frequency, the second frequency being an operating frequency of a second PHY interface;

c) if the clock frequency is the first frequency, setting the switch to the first interface; and

d) if the clock frequency is the second frequency, setting the switch to the second interface.

The step of setting the switch to one or the other interface may comprise changing to that interface. Alternatively, if the switch is already in that interface, no change may be required.

Preferably, step b) further comprises determining whether the clock frequency is a third frequency, the third frequency being an operating frequency of a third PHY interface and wherein the method further comprises step e) of, if the clock frequency is the third frequency, setting the switch to the third interface.

One of the interfaces may be TBI. One of the interfaces may be MII. One of the interfaces may be GMII. In one embodiment, the three interfaces are TBI, MII and GMII.

According to another embodiment of the invention, there is provided a method for determining, in a switch, the physical layer device (PHY) interface and for setting the switch to that interface, the method comprising the steps of:

a) detecting the clock frequency of a received signal;

b) determining whether the clock frequency is a selected frequency, the selected frequency being an operating frequency of a selected PHY interface; and

c) if the clock frequency is the selected frequency, setting the switch to the selected interface.

According to another embodiment of the invention, there is provided a method for determining whether the mode of operation of a physical layer device (PHY) in an Ethernet switch is TBI, MII or GMII and for setting the Ethernet switch to that mode, the method comprising the steps of:

a) detecting the clock frequency of a received signal;

b) determining whether the clock frequency is a first frequency, the first frequency being an operating frequency of TBI,

c) if the clock frequency is the first frequency, setting the switch to TBI mode;

d) determining whether the clock frequency is a second frequency, the second frequency being an operating frequency of MII;

e) if the clock frequency is the second frequency, setting the switch to MII mode;

f) determining whether the clock frequency is a third frequency, the third frequency being an operating frequency of GMII;

g) if the clock frequency is the third frequency, setting the switch to GMII mode.

Thus, the clock frequencies of TBI, MII and GMII can be detected and the switch can be set to the appropriate mode. The steps of the method may be performed sequentially (either in the order above or in another order) or the steps may be performed simultaneously. The method includes the steps of detecting the frequency, determining the appropriate interface and changing the interface on the switch side.

Preferably, the PHY is arranged to use a TBI PHY module, a MII PHY module or a GMII PHY module. Preferably, the PHY is arranged to use a TBI physical link medium, a MII physical link medium or a GMII physical link medium. That is, the PHY has TBI, MII and GMII functionalities.

Step c), of setting the switch to TBI mode, may comprise setting the PHY to use a TBI PHY module or a TBI physical link medium. Similarly, step e) of setting the switch to MII mode, may comprise setting the PHY to use a MII PHY module or a MII physical link medium. Similarly, step g) of setting the switch to GMII mode may comprise setting the PHY to use a GMII PHY module or a GMII physical link medium.

Step a) of detecting the clock frequency of a signal received on the PHY is preferably performed by at least one frequency detector. In an embodiment of the invention, the clock frequency is detected by two frequency detectors. In another embodiment of the invention, the clock frequency is detected by three frequency detectors. In the latter embodiment, one of the detectors is arranged to detect TBI clock frequency, the second detector is arranged to detect MII clock frequency and the third detector is arranged to detect GMII clock frequency.

In one embodiment, the first frequency, i.e., the TBI frequency, is 62.5 MHz. In one embodiment, the second frequency, i.e., the MII frequency, is either 2.5 MHz or 25 MHz. In one embodiment, the third frequency, i.e., the GMII frequency, is 125 MHz.

According to another embodiment of the invention, there is provided a method for determining whether the mode of operation of the physical layer device (PHY) in a switch is a first mode, a second mode or a third mode and for setting the switch to that mode, the method comprising the steps of:

a) detecting the clock frequency of a received signal;

b) determining whether the clock frequency is a first frequency, the first frequency being an operating frequency of the first mode;

c) if the clock frequency is the first frequency, setting the switch to the first mode by setting the PHY to use a first mode PHY module;

d) determining whether the clock frequency is a second frequency, the second frequency being an operating frequency of the second mode;

e) if the clock frequency is the second frequency setting the switch to the second mode by setting the PHY to use a second mode PHY module;

f) determining whether the clock frequency is a third frequency, the third frequency being an operating frequency of the third mode;

g) if the clock frequency is the third frequency, setting the switch to the third mode by setting the PHY to use a third mode PHY module.

Thus, the appropriate mode in a switch can be determined by frequency detection and the interface can be changed on the switch side. A first mode physical link medium may be connected to the first mode PHY module. A second mode physical link medium may be connected to the second mode PHY module. A third mode physical link medium may be connected to the third mode PHY module.

In one embodiment, the first mode is TBI. In that case, the first clock frequency may be 62.5 MHz and a fiber cable may be connected to the TBI PHY module.

In one embodiment, the second mode is MII. In that case, the second clock frequency may be either 2.5 or 25 MHz and a copper cable may be connected to the MII PHY module. In one embodiment, the third mode is GMII. In that case, the third clock frequency may be 125 MHz and a copper cable may be connected to the GMII PHY module.

According to another embodiment of the invention, there is provided apparatus for determining the mode of operation of a physical layer device (PHY) in a switch and for setting the switch to that mode, the apparatus comprising:

a first frequency detector for detecting a first frequency, the first frequency being an operating frequency of a first PHY mode, the first detector being arranged, on receipt of a signal having a clock frequency of the first frequency, to set the switch to the first mode; and

a second frequency detector for detecting a second frequency, the second frequency being an operating frequency of a second PHY mode, the second detector being arranged, on receipt of a signal having a clock frequency of the second frequency, to set the switch to the second mode.

The apparatus may further comprise a third frequency detector for detecting a third frequency, the third frequency being an operating frequency of a third PHY mode, the third detector being arranged, on receipt of a signal having a clock frequency of the third frequency, to set the switch to the third mode.

One of the modes may be TBI. One of the modes may be MII. One of the modes may be GMII. In one embodiment, the three modes are TBI, MII and GMII.

According to another embodiment of the invention, there is provided apparatus for determining whether the mode of operation of a physical layer device (PHY) in an Ethernet switch is TBI mode, MII mode or GMII mode and for setting the Ethernet switch to that mode, the apparatus comprising:

a first frequency detector for detecting a first frequency, the first frequency being an operating frequency of TBI, the first detector being arranged, on receipt of a signal having a clock frequency of the first frequency, to set the switch to TBI mode;

a second frequency detector for detecting a second frequency, the second frequency being an operating frequency of MII, the second detector being arranged, on receipt of a signal having a clock frequency of the second frequency, to set the switch to MII mode; and

a third frequency detector for detecting a third frequency, the third frequency being an operating frequency of GMII, the third detector being arranged, on receipt of a signal having a clock frequency of the third frequency, to set the switch to GMII mode.

Preferably, the PHY is configured to use a TBI PHY module, a MII PHY module or a GMII PHY module. That is, the PHY includes TBI, MII and GMII functionalities. A TBI physical link medium (for example a fiber cable) may be connected to the TBI PHY module. A MII physical link medium (for example a copper CAT 5 cable) may be connected to the MII PHY module. A GMII physical link medium (for example a copper CAT 5 cable) may be connected to the GMII PHY module.

Setting the switch to TBI mode preferably comprises setting the interface on the switch side to TBI. Setting the switch to MII mode preferably comprises setting the interface on the switch side to MII. Setting the switch to GMII mode preferably comprises setting the interface on the switch side to GMII.

Preferably, the switch is on a chip. The first, second and third frequency detectors may be at different locations.

According to another embodiment of the invention, there is provided apparatus for determining the mode of operation of a physical layer device (PHY) in a switch and for setting the switch to that mode, the apparatus comprising a frequency detector for detecting a selected frequency, the selected frequency being an operating frequency of a selected PHY mode, the detector being arranged, on receipt of a signal having a clock frequency of the selected frequency, to set the switch to the selected mode.

### BRIEF DESCRIPTION OF THE DRAWINGS

The foregoing aspects and many of the attendant advantages of this invention will become more readily appreciated as the same become better understood by reference to the following detailed description, when taken in conjunction with the FIGURE, which is block diagram used to show the steps of the method of the invention according to a preferred embodiment.

### DETAILED DESCRIPTION OF ILLUSTRATIVE EMBODIMENTS

In one aspect, the invention describes a way to differentiate between different types of interfaces (e.g., MII, GMII and TBI) that are connected to an Ethernet switch chip and it allows a hot swap of different interfaces without the need for power strapping pins or for a power restart. Embodiments of the invention make use of the chip receive clock (RXCLK) of each Ethernet interface to distinguish between the different interfaces. The RXCLK is sent out by each PHY device. As is well known, the RXCLK is the clock (CLK) for a given received (RX) signal. For different interfaces, the RXCLK frequency will be different.

The embodiment of the invention illustrated in the FIGURE relies on the different frequencies of the RXCLK in the different modes. In TBI, the RXCLK frequency is 62.5 MHz. In MII, the RXCLK operates at 2.5 MHz or 25 MHz. In GMII, the RXCLK frequency is 125 MHx.

The FIGURE provides a block diagram showing three filters and associated detectors. The outputs of the detectors are provided to blocks that illustrate the functionality of setting the appropriate switch to the appropriate mode. This embodiment can be used to determine which interface or mode is being used and to switch between the different modes.

The RXCLK is received at a clock node and passed through various frequency filters 101, 103 and 105. The first filter 101 is a TBI filter (which allows through 62.5 MHz TBI only), the second filter 103 is a MII filter (which allows through 2.5 MHz or 25 MHz MII only) and the third filter 105 is a GMII filter (which allows through 125 MHz GMII only). The RXCLK may be detected by one of three detectors 107, 109 and 111. The RXCLK may be passed through the three filters simultaneously or it may be passed through the three filters sequentially. TBI detector 107 detects only the TBI (62.5 MHz) frequency, detector 109 detects only the MII (2.5 or 25 MHz) frequency and detector 111 detects only the GMII (125 MHz) frequency.

If the RXCLK frequency is 62.5 MHz (i.e., the PHY is sending out a 62.5 MHz clock), the RXCLK signal will not pass through the MII filter 103 or the GMII filter 105 but it will pass through the TBI filter 101 and be detected by TBI detector 107. The TBI detector, by virtue of receiving the TBI frequency RXCLK, will know that the mode is now TBI and will set the Ethernet switch (after the necessary initialization) to TBI mode.

If the RXCLK frequency is not 62.5 MHz, the RXCLK signal will not pass through the TBI filter 101. If the RXCLK frequency is 2.5 MHz or 25 MHz, (i.e., the PHY is in the MII interface and is transmitting a 2.5 or 25 MHz clock) the RXCLK signal will not pass through the GMII filter 105 but it will pass through the MII filter 103 and be detected by the MII detector 109. The MII detector, by virtue of receiving the MII frequency RXCLK, will know that the mode is now MII and will set the Ethernet switch (after the necessary initialization) to MII mode.

If the RXCLK frequency is not 62.5 MHz, 2.5 MHz or 25 MHz, the RXCLK signal will not pass through the TBI filter 101 or the MII filter 103. If the RXCLK frequency is 125 MHz, (i.e., the PHY is in the GMII interface and is transmitting at 125 MHz) the RXCLK signal will pass through the GMII filter 105 and be detected by the GMII detector 111. The GMII detector, by virtue of receiving the GMII frequency RXCLK, will know that the mode is now GMII and will set the Ethernet switch (after the necessary initialization) to GMII mode.

In a preferred arrangement, each PHY module carries out the frequency detection steps. In that arrangement, each PHY module includes all the appropriate frequency filters and detectors, so that the PHY module can work independently. This means that only traffic in the vicinity of the PHY module need be affected when the interface is changed. In that case, only one of the frequency filters and one of the frequency detectors is active at a time; the other filters and detectors remain inactive. For example, when TBI is the selected interface only the TBI filter and detector will be active, while the MII and GMII filters and detectors remain inactive.

In another arrangement, the frequency detection steps are carried out centrally.

In another arrangement, some of the frequency detection steps are carried out in the PHY module and some of the frequency detection steps are carried out centrally. For example, the frequency detection may take place in two stages as follows. Firstly, a distinction may be made between TBI on the one hand and MII and GMII on the other hand. TBI RXCLK will be allowed through the TBI filter, whereas RXCLK MII or RXCLK GMII will not be allowed through the TBI filter. Secondly, for RXCLK, which is not TBI, a distinction may be made between MII on the one hand and GMII on the other hand. MII RXCLK will be allowed through the MII filter whereas GMII RXCLK will not. Thus, the two steps of frequency detection may be carried out at different frequency detectors which may be located at different locations.

By making use of the RXCLK, which is characteristic of Ethernet interfaces, the particular frequency of the RXCLK can be detected by the frequency detectors. Thus, the correct mode for the PHY layer can be determined and the switch can initialize and change to the appropriate mode, i.e., the PHY modules can be changed.

There is no need for a power down or for the switch chip to be reset, nor is there any need for power strapping pins. The preferred embodiment of the invention allows a hot swap between interfaces while the system is in operation. Thus, only local traffic (i.e., traffic in the particular modules being changed) is affected so the interruption to traffic and the downtime required is greatly reduced.

The embodiment described relates only to Ethernet switches operating between TBI, MII and GMII modes. However, it should be understood by a person skilled in the art the invention is not limited to Ethernet switches operating between TBI, MII and GMII modes, but is also applicable to other applications which require such a technique. Examples of other applications are an ATM to Ethernet converter and a Resilient Packet Ring (RPR). More or fewer than three different frequencies can be used.

While the preferred embodiment of the invention has been illustrated and described, it will be appreciated that various changes can be made therein without departing from the spirit and scope of the invention as defined by the appended claims.

What is claimed is:

1. A method for determining, in a switch, the physical layer device (PHY) interface and for setting the switch to that interface, the method comprising the steps of:
a) detecting the clock frequency of a received signal;
b) determining whether the clock frequency is a first frequency, the first frequency being an operating frequency of a first PHY interface, or whether the clock frequency is a second frequency, the second frequency being an operating frequency of a second PHY interface;
c) if the clock frequency is the first frequency, setting the switch to the first interface; and
d) if the clock frequency is the second frequency, setting the switch to the second interface.

2. The method of claim 1 wherein step b) further comprises determining whether the clock frequency is a third frequency, the third frequency being an operating frequency of a third PHY interface and wherein the method further comprises step e) of, if the clock frequency is the third frequency, setting the switch to the third interface.

3. The method of claim 1 wherein one of the interfaces is TBI.

4. The method of claim 1 wherein one of the interfaces is MII.

5. The method of claim 1 wherein one of the interfaces is GMII.

6. A method for determining whether the mode of operation of a physical layer device (PHY) in an Ethernet switch is TBI, MII or GMII and for setting the Ethernet switch to that mode, the method comprising the steps of:
a) detecting the clock frequency of a received signal;
b) determining whether the clock frequency is a first frequency, the first frequency being an operating frequency of TBI;
c) if the clock frequency is the first frequency, setting the switch to TBI mode;
d) determining whether the clock frequency is a second frequency, the second frequency being an operating frequency of MII;
e) if the clock frequency is the second frequency, setting the switch to MII mode;
f) determining whether the clock frequency is a third frequency, the third frequency being an operating frequency of GMII; and
g) if the clock frequency is the third frequency, setting the switch to GMII mode.

7. The method of claim 6 wherein steps b), d) and f) are carried out simultaneously.

8. The method of claim 6 wherein steps b), d) and f) are carried out sequentially.

9. The method of claim 6 wherein step c) of setting the switch to TBI mode comprises setting the PHY to use a TBI PHY module.

10. The method of claim 6 wherein step e) of setting the switch to MII mode comprises setting the PHY to use a MII PHY module.

11. The method of claim 6 wherein step g) of setting the switch to GMII mode comprises setting the PHY to use a GMII PHY module.

12. The method of claim 6 wherein step a) of detecting the clock frequency of a signal received on the PHY is performed by at least one frequency detector.

13. The method of claim 6 wherein the first frequency is 62.5 MHz.

14. The method of claim 6 wherein the second frequency is either 2.5 MHz or 25 MHz.

15. The method of claim 6 wherein the third frequency is 125 MHz.

16. Apparatus for determining the mode of operation of a physical layer device (PHY) in a switch and for setting the switch to that mode, the apparatus comprising:
a clock node;
a first frequency detector for detecting a first frequency, the first frequency being an operating frequency of a first PHY mode, the first detector being arranged, upon receipt of a signal carried at the clock node and having a clock frequency of the first frequency, to cause the switch to be set to the first mode; and
a second frequency detector for detecting a second frequency, the second frequency being an operating frequency of a second PHY mode, the second detector being arranged, upon receipt of a signal carried at the clock node and having a clock frequency of the second frequency, to cause the switch to be set to the second mode.

17. The apparatus of claim 16 further comprising a third frequency detector for detecting a third frequency, the third frequency being an operating frequency of a third PHY mode, the third detector being arranged, upon receipt of a signal carried at the clock node and having a clock frequency of the third frequency, to cause the switch to be set to the third mode.

18. The apparatus of claim 16 wherein one of the modes is TBI.

19. The apparatus of claim 16 wherein one of the modes is MII.

20. The apparatus of claim 16 wherein one of the modes is GMII.

21. Apparatus for determining whether the mode of operation of a physical layer device (PHY) in an Ethernet switch is TBI mode, MII mode or GMII mode and for setting the Ethernet switch to that mode, the apparatus comprising:
a clock node;
a first frequency detector for detecting a first frequency, the first frequency being an operating frequency of TBI, the first detector being arranged, on receipt of a signal carried at the clock node and having a clock frequency of the first frequency, to cause the switch to be set to TBI mode; and
a second frequency detector for detecting a second frequency, the second frequency being an operating frequency of MII, the second detector being arranged, on receipt of a signal carried at the clock node and having a clock frequency of the second frequency, to cause the switch to be set to MII mode; and
a third frequency detector for detecting a third frequency, the third frequency being an operating frequency of GMII, the third detector being arranged, on receipt of a signal carried at the clock node and having a clock frequency of the third frequency, to cause the switch to be set to GMII mode

22. The apparatus of claim 21 wherein the PHY is configured to use a TBI PHY module, a MII PHY module or a GMII PHY module.

23. The apparatus of claim 21 wherein the switch is on a chip.

24. A method for determining, in a switch, the physical layer device (PHY) interface and for setting the switch to that interface, the method comprising the steps of:
a) detecting the clock frequency of a received signal;
b) determining whether the clock frequency is a selected frequency, the selected frequency being an operating frequency of a selected PHY interface; and
c) if the clock frequency is the selected frequency, setting the switch to the selected interface.
